(19) United States
(12) Patent Application Publication
(10) Pub. No.: US 2022/0051128 A1
(43) Pub. Date: Feb. 17, 2022

(54) PREDICTING CUSTOMER INTERACTION OUTCOMES

(71) Applicant: International Business Machines Corporation, Armonk, NY (US)

(72) Inventors: Petar Ristoski, San Jose, CA (US); Markus Ettl, Yorktown Heights, NY (US); Youssef Drissi, Peekskill, NY (US); Chek Keong Tan, Danbury, CT (US); Anna Lisa Gentile, San Jose, CA (US); Herbert Scott McFaddin, Yorktown Heights, NY (US); Wei Sun, Tarrytown, NY (US)

(21) Appl. No.: 16/993,305

(22) Filed: Aug. 14, 2020

(51) Int. Cl. G06N 20/00; G06Q 30/00; G06Q 30/02

(52) U.S. Cl. CPC G06N 20/00; G06Q 30/0202; G06Q 30/01

(57) ABSTRACT

Predictive analysis of customer relationship management elements by receiving service feature data associated with past services, receiving customer feature data, including customer interaction outcome data, for a set of customers associated with the past service, training a machine learning model according to the received feature data and customer feature data, and providing the trained machine learning model to a user, the model configured for predicting a future customer interaction outcome probability according to service feature data associated with a current service, and customer feature data associated with customers of the current service.

### BACKGROUND

The disclosure relates generally to computer-based Customer Relationship Management (CRM) solutions. The disclosure relates particularly to performing predictive analysis with respect to particular elements within computer-based CRM solutions.

Service industries, such as car rentals, hospitality, financial service, telecommunications, airline travel, insurance, financial services, etc., receive limited feedback on their performance. Customers may provide no feedback rather than either positive or negative feedback in response to the provided services.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable tensor comparisons and communications associated with tensor similarities.

Aspects of the invention disclose methods, systems and computer readable media associated with predictive analysis of customer relationship management elements by receiving service feature data associated with past services, receiving customer feature data, including customer interaction outcome data, for a set of customers associated with the past services, training a machine learning model according to the received service feature data and customer feature data, and providing the trained machine learning model to a user, the model configured for predicting a future customer interaction outcome probability according to service feature data associated with a current service, and customer feature data associated with customers of the current service.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts data flow and operational steps, according to an embodiment of the invention.

FIG. 4 depicts a cloud computing environment, according to an embodiment of the invention.

FIG. 5 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

In an embodiment, one or more components of the system can employ hardware and/or software to solve problems that are highly technical in nature (e.g., training a machine learning model using service feature and customer feature data, using the trained machine learning model to predict customer outcomes and actions, etc.). These solutions are not abstract and cannot be performed as a set of mental acts by a human due to the processing capabilities needed to facilitate predicting customer actions, for example. Further, some of the processes performed may be performed by a specialized computer for carrying out defined tasks related to customer outcome prediction. For example, a specialized computer can be employed to carry out tasks related to predicting customer interaction outcomes or the like.

Details of the disclosed invention will be provided using the airline industry as an example. The example of the airline industry is not intended to limit the scope of the disclosed inventions in any manner.

During a typical year there are more than 40 million commercial flights worldwide, carrying more than 5 billion customers, making the airline industry extremely competitive. A key to a long-term success of an airline company—or any other service industry—is customer satisfaction. The strongest evidence of customers' dissatisfaction are their complaints. Therefore, identifying situations that can lead to complaints is of crucial value for the airline industry. Once identified, such situations enable the service provider to prepare and address such situations, lessening any negative impact upon customer satisfaction.

Though every service, flight or travel moment cannot be personalized, acknowledging people as individuals and customizing messaging to customers lets passengers know they're seen beyond a price point. The frontline teams at major airlines interact with hundreds of thousands of people each day. Disclosed embodiments proactively identify customers that have the highest probability of taking an action upon an adverse service interaction, thereby empowering frontline teams with information to prepare and deliver a more timely, relevant and impactful customer service experience. Identifying and improving the customer experience for passengers who are experiencing service disruptions, such as arrival delays or multiple prioritized service issues, enables higher customer satisfaction and increased customer loyalty.

In an embodiment, the method receives service data as an input. The input data represents a set of past services, each service of the set including a set of service features. As an example, the input data includes a set of airline flights F=[f₁, f₂, . . . , fₘ], where each flight includes a set of features X_{f}=[x_{f1}, x_{f2}, . . . , x_{fk}], of size k. For each flight (service), the input data also includes a set of n customers C₁=[c₁, c₂, c₃, . . . , cₙ], with each customer further represented by a set of customer features X_{c}=[x_{c1}, x_{c2}, . . . , x_{c1}] of size l. In this embodiment, the method ranks the customers of each service according to the customer's probability of acting upon an adverse outcome, by, for example, lodging a complaint about the service. The method ranks customers from the highest to the lowest probability of taking an action.

In response to receiving the input data, the method extracts the service features and customer features for each service and each customer of each service, respectively. The method then develops and trains a machine learning model (a “customer level model”) for the purpose of ranking customers for each service, based on their probability of taking an action. The customer level model utilizes the customers associated with each past service to generate the list of service customers, ranked according to customer probability of acting upon an adverse interaction, e.g., a customer complaint. The customer level model provides a list of customers ranked using a normalized customer action scale between 0 and 100—a customer ranked 100 has a 100% probability of acting upon the adverse interaction. The customer level model is utilized in real-time to evaluate which customers of which service are most likely to act upon an adverse interaction, enabling proactive steps to be taken with regard to these customers prior to the customer acting upon the adverse interaction.

For training the customer-level model, the method extracts customer features for each customer of each past service. Extracted customer features include customer and loyalty program features, such as membership status, lifetime flown miles, lifetime spent money, airline awards etc. These features are updated for each customer after each new flight. Customer features further include booking features related to each newly booked flight by the customer, such as, leg origin, leg destination, type of flight (domestic or international), number of hops, etc. Customer features further include flight operations features, such as type of the flight, number of passengers on the flight, and all flight-specific features. Concatenating the flight features to the customer features enables the identification of different patterns and combinations of customer and flight features that increase a customer's probability of taking an action upon an adverse service interaction. The categorical and numeric customer features are hot encoded and standardized respectively as noted above. For non-airline service, customer features include customer—service provider relationship features, specific service scheduling and requesting features, and specific service features common to all customers of a specific service.

In an embodiment, the method considers the task of ranking the set of customers of each flight (service) according to the individual customer's probability of complaining, as a binary classification task. The method utilizes the confidence score of the classification model for ranking the set of customers. As complaints constitute a small (less than 1%) of all customer interactions, the method over-samples the set of customer complaints, e.g., over sampling the minority class by a factor of 5, and we under-sample the majority class to have the same size as the minority class after over-sampling. The method builds four different binary classification models for the customer level binary classification, random forest, logistic regression, gradient boosted trees, and multilayer feed-forward neural network models.

The instances of complaints represent a small (<1%) number of all customer interactions. For this reason, the method utilizes an autoencoder to identify anomalies in the input data set. The method models the distribution of normal (non-complaint) data and seeks to identify instances outside the modeled distribution. An autoencoder comprises an encoder and a decoder. The autoencoder input and output are the same. The autoencoder compresses the input and seeks to reconstruct the input as an identical output using learned features of the data. Large errors in the reconstruction of the data indicate an outlier—anomalous data instance. Outliers indicate customers likely to complain. Interpretation of the autoencoder results provides an indication of the data instance features which contribute to the likelihood to complain—the outlier status. For the method, customers having a high probability of complaining constitute outlier data instances due to the low percentage of customer complaint instances in the overall data set.

In further training the machine learning model, the method develops a learn-to-rank (LTR) module which receives the set of outlier data instances from the autoencoder, or other anomaly identification module, and learns to rank the entire list of customers associated with each service (flight) in descending order according to the predicted probability of the customer filing a complaint about the particular flight. Rather than minimizing the loss function for a model generating a prediction for a single customer, the LTR (learn-to-rank) algorithm seeks to minimize the loss function associated with scoring the entire set of customers associated with each service. In an embodiment, the LTR model varies the loss function tolerance according to the position of a customer in the overall ranking of the set of customers. In this embodiment, the LTR algorithm tolerates less error in association with the customers ranked as having the highest probability of complaining. The top N ranked customers are expected to be the most likely to complain. For this model, the customer feature set dominates the model's node weighting algorithm. Pairwise LTR models such as RankNet, RankSVM, RankBoost may be used to rank the lists of customers. Similarly, a Listwise LTR model such as LambdaMART may be used in ranking the customer lists.

In an embodiment, the method trains the LTR model. The method defines groups and an ordered list of items with a feature vector. As an example, the method defines groups for each combination of origin airport and destination airport, creating a new group for each pairing, e.g., O1-D1, O2-D2, O3-D3, O4-D4 etc. For each flight in each group the method extracts a flight feature vector Ff, and for each passenger on each flight, the method extracts a customer feature vector Cf. The method concatenates the flight and customer feature vectors, resulting in a concatenated vector Ff=[f_{f1}, f_{f2}, . . . f_{fn}] ∪ Cf=[c_{f1}, c_{f2}, . . . , c_{fn}].

The flight feature vector Ff will be different for each flight on each date, e.g., O1-D1 on MM.DD.YYYY was delayed 10 minutes, but the next day was delayed 240 minutes. The Ff vectors for the two flights will differ at least because of this difference. For each customer on a given flight, the flight feature vector is the same, e.g., all 134 passengers O1-D1 on MM.DD.YYYY are delayed 240 minutes. The method extracts a different customer vector for each customer.

In this embodiment, the method trains a first LTR model using unweighted features—such as the flight features where each customer has the same feature vector, and a second LTR model having weighted features, such as the customer feature vectors, where each customer has a different feature vector.

Weighing the flight features for each passenger differently is important as they have different meaning for each passenger; e.g., a business traveler might not be disturbed by a slight delay as they have experienced it often, while a vacation traveler might be disturbed even with slight inconveniences (e.g., long taxi time).

To weight the flight features the method considers the flight values of each customer in their history of travels and calculates how different the current flight features are from the customer's flight history.

The method utilizes two approaches. In one approach, the method evaluates deviations from the normal distribution of historic values for the passenger, e.g., a flight delay of 30 mins for a not-frequent flier will have much higher weight, than the same delay for a frequent flier. In a second approach, the method builds an autoencoder for all past flights for each passenger—the method then assigns the feature vectors' reconstruction error as weights for the current flight. Using each approach, the method ensures that the flight features for each customer include the real context, and not only result in a correctly ordered customer list, but also in customer scores on the ordered list that are more meaningful.

A trained time series model enables predictions for current or future events according to data associated with series of past events. Training the time series model requires a rich data set—a data set having a non-zero value for each time stamped event. Customer complaint data sets tend to be sparse rather than rich—few, if any non-zero values for each time stamped event. As an example, a customer may complain once every 500 flights, yet the average customer flies only twice a year, generating insufficient time series data to train a model. Applicable time series models include linear regression, autoregression—moving average, and recurrent neural network, log short term memory (RNN LSTM) models.

In an embodiment, the method utilizes a historic data set associated with a set of complaining customers to train a scoring function which generates a continuous set of time stamped data from a sparse binary set of time stamped data—all values either 0 or 1 and few actual non-zero values.

In an embodiment, the method utilizes the binary classification models, the anomaly detection models and the LTR models to generate a time-stamped set of customer complaint probability values. For each customer, flight data is ordered by time from furthest back in time to most recent. For each flight, the method uses the binary classification, anomaly detection and LTR models, alone or in combination, to predict a complaint probability score between 0 and 1 for each service event having a nominal value of 0 for the customer—no complaint for that customer on that flight. The method then utilizes the predicted set of probability values for each customer to train the time series model enabling time series model predictions for current customers on current flights. The model may include the binary classification model, the anomaly detection model, the LTR model, or a combination of these models. For models including more than one of these, the prediction scores from each included model are averaged to derive a prediction score for the input data. In an embodiment, the method utilizes a univariate time series training and prediction approach. In this embodiment, the method trains the model using time series data consisting of a single vector value for each time-stamped event for each customer. The method extracts flight and customer feature vectors for each customer on each flight in the input data set. The method determines the single value for each time-stamped event as the average of the predicted complaint probability values for the event and the customer from each of the binary classification, anomaly detection, and LTR models, using the extracted feature vectors. The trained model provides a complaint prediction for each customer on a current or future flight by predicting the next value in a time series of data according to the flight and customer feature vectors for each customer. The method considers the set of customers for each flight rather than evaluating the probability associated with a single customer.

In an embodiment, the method utilizes a multivariate approach for training and use of the time series model. In this embodiment, the method extracts flight and customer feature vectors for each input data set event, and utilizes the average score from the binary classification, anomaly detection, and LTR models for each flight-customer event, plus the complete customer feature vector for each customer of the flight-customer event, to train the time series model. The method then utilizes the trained model to predict the next value in the time series of customer complaint probabilities according to flight and customer feature vectors for current and future flight-customer events. The method considers the set of customers for each flight rather than evaluating the probability associated with a single customer.

In an embodiment, the method trains and utilizes the time series model to evaluate the entire set of time series data, such as utilizing a long short term memory (LSTM) model to identify patterns in a complete set of time series data and to predict the complaint probabilities for the set of customers on a current or future flight according to patterns in the set of time series data rather than as a prediction of the next value of the time series data. In this embodiment, the method extracts feature vectors for each flight-customer event in the input data, and predicts complaint probabilities as described above using binary classification, anomaly detection and LTR models. The method then averages the probability scores and utilizes the average probability score as the score for each customer time-stamped event having an original complaint value of 0. The trained model outputs a list of customers, for each flight, ranked in descending probability of complaint, order. Unlike regression models, the LSTM model considers the entire set of time series data and provides the predicted output according to network node weights associated with the data patterns present in the overall time series set. The method considers the set of customers for each flight rather than evaluating the probability associated with a single customer.

In an embodiment, the method utilizes Shapley additive explanation (SHAP) analysis, or similar analytic methods, to interpret the output of the method. The SHAP analysis provides an indication of the relative contribution of each feature vector element to the overall prediction. The analysis provides a rank ordering from greatest contributor to least contributor as well as providing an indication of the nature of the contribution—such as whether the element contributed to increasing the predicted probability or to decreasing the predicted probability. The analysis enables a user to identify service aspects contributing to higher complaint likelihood as well as service aspects which ameliorate complaint propensities.

In an embodiment, the use of the method enables a service provider to evaluate current and planned services and to identify service—customer combinations which are more likely to result in a dissatisfied customer and potentially a customer complaint. This identification enables the service provider to take proactive actions to reduce the customer dissatisfaction levels and improve provider-customer relationships.

Predicting when a customer is about to complain and enabling action before the complaint improves customer satisfaction. Learning the patterns that lead to a complaint from historical booking data is not trivial because customers rarely complain to the airline when they experience a service disruption. From a machine learning point of view, the available data is highly imbalanced; complaints may represent less than 1% of all the data.

Service industries seek to achieve and maintain high levels of customer satisfaction. Anticipating when a customer is likely to complain about a service experience plays an important role in supporting customer care and frontline teams to deliver a personalized experience and to increase customer loyalty and retention. The disclosure uses the airline industry as an example. Disclosed embodiments have applicability to most service industries, such as car rental, hospitality, restaurants, telecommunications, financial service, etc.

Disclosed systems and methods enable prediction of the likelihood of a traveler to complain. Disclosed methods rank passengers on each flight according to their propensity to act upon service disruption by complaining, etc. Disclosed methods enable customer care teams to deliver a more personalized customer experience, understand customer behavior and help an airline (service provider) to determine when to dispatch a frontline agent to greet an arriving delayed flight. Insights from the customer-level models provide an effective means for improved customer engagement, helping to optimize compensation for disrupted customers during pre-travel (off-boarding in oversold situations) or post-travel (flight delays or cancellations).

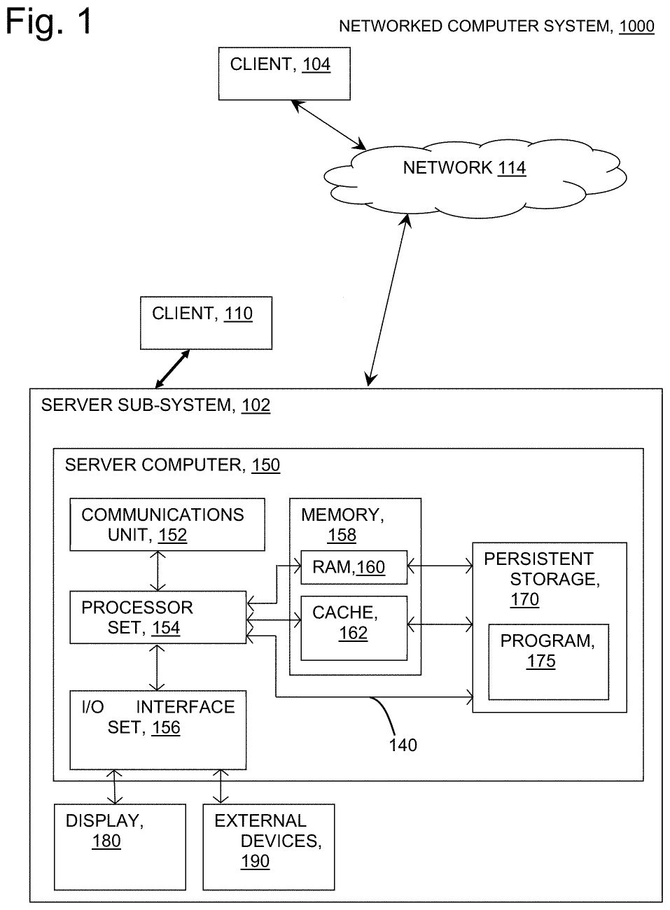

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise application program (not shown) together with sufficient computing resource (processor, memory, network communications hardware) to execute the program. As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the customer outcome prediction program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., customer outcome prediction program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

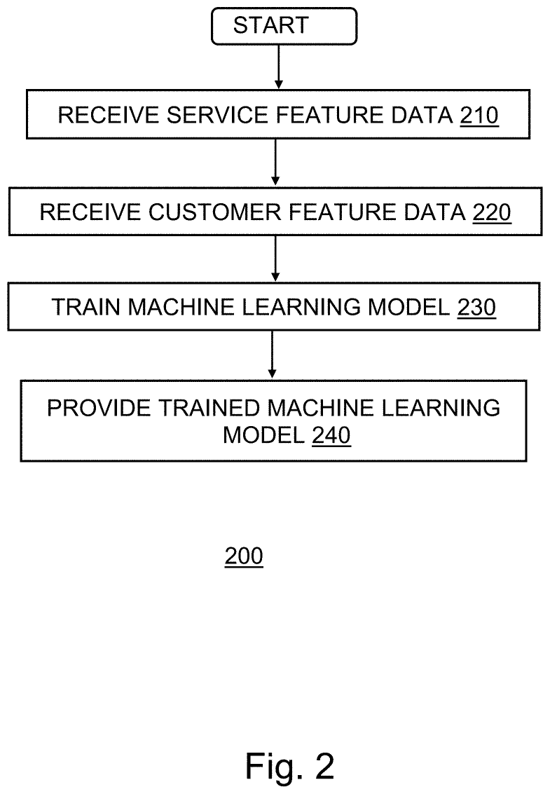

FIG. 2 provides a flowchart 200, illustrating exemplary activities associated with the practice of the disclosure. After program start, at block 210, the method of customer outcome prediction program 175 receives input data including service feature data relating to historic, past, services. At block 220, the method of customer outcome prediction program 175 receives customer feature data associated with customers of each of the past services.

At block 230 the method of customer outcome prediction program 175 trains a machine learning model using the customer and service feature data. In an embodiment, the machine learning model include binary classification models, anomaly detection models, and learn-to-rank (LTR) models for generating probabilities for an action in response to an adverse customer experience, or service interaction, according to the customer and service feature data. In an embodiment, the machine learning model further includes a time series model configured to generate a ranked listing of current or future customers associated with a current or future service, respectively. The method ranks the customer listing according to a predicted probability of the customer taking an action in response to an adverse customer experience—e.g., complaining. In this embodiment, the method trains the time series model using continuous time series data generated from the service and customer feature vectors according to probability scores predicted by one or more of the binary classification, anomaly detection, or LTR models.

At bock 240, the method provides the trained machine learning model to a user. In an embodiment, the trained machine learning model predicts probabilities associated with actions in response to an adverse customer experience, for a set of customers associated with a current or future service. The model provides a listing of the customers ranked according to a descending probability of taking an action.

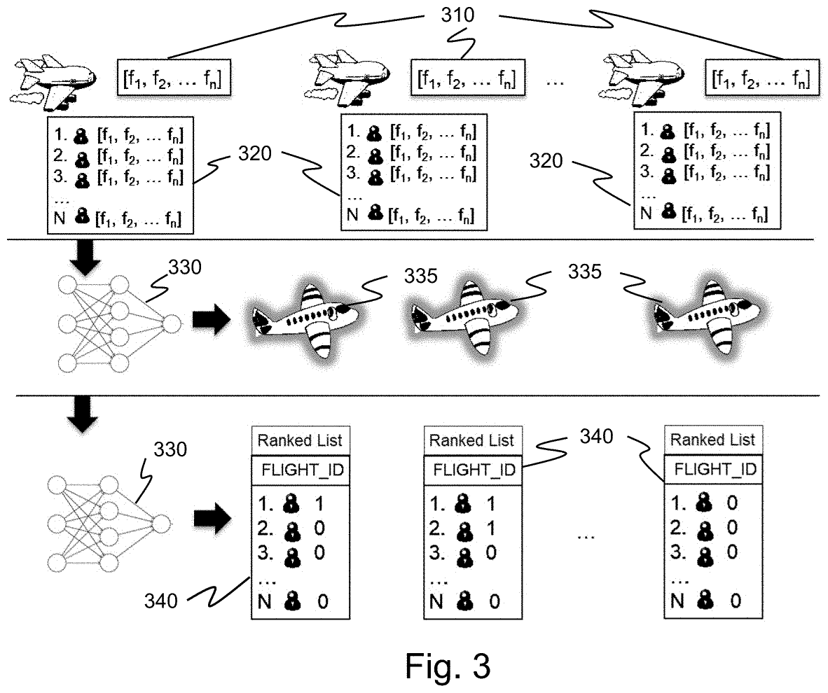

FIG. 3 provides a schematic illustration of data flow and operational steps according to an embodiment of the invention. As shown in the figure, the method extracts flight level feature vectors, 310, and customer level feature vectors 320 from past data associated with flights and the customers of each flight.

The method utilizes flight level feature vectors 310 and customer level feature vectors 320 in the training of a machine learning model 330. The machine learning model 330 includes one or more of binary classification models, anomaly detection models, learn-to-rank models, and time series probability prediction models. In use, machine learning model 330 predicts consumer complaint probabilities for current or future flights 335. In an embodiment, the method provides a listing of flights having the highest probability of leading to customer complaints.

As shown in FIG. 3, for each flight 335, machine learning model 330 further provides a listing 340, of customers on the flight, ranked in descending order according to the probability that the customer will be dissatisfied and file a complaint regarding the flight or service.

The model provides a user with the predicted probabilities. The user may request probability predictions according to planned or current service, or according to the current or future service-customer combination most likely to lead to an action in response to an adverse customer experience.

Extracting feature vectors from large data sets (millions of records) as well as training the respective portions of the disclosed machine learning models, and utilizing the trained model for probability predictions may require the utilization of networked computing resources beyond those locally available to a user and may necessitate the utilization of edge cloud or cloud resources. Edge cloud and cloud resources may enable better and more timely utilization of trained models by a distributed set of users evaluating and addressing service issues across a large geographic area.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

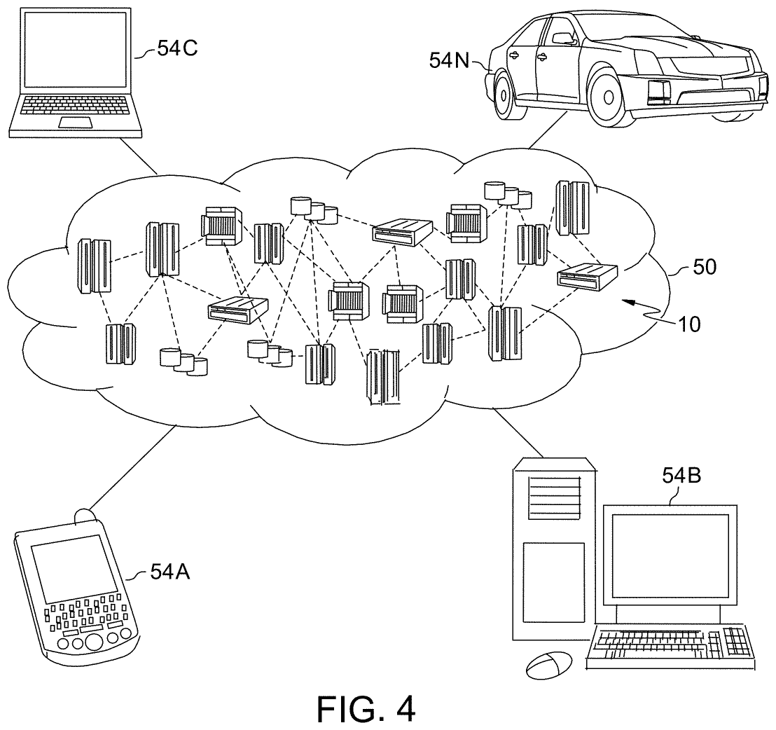

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

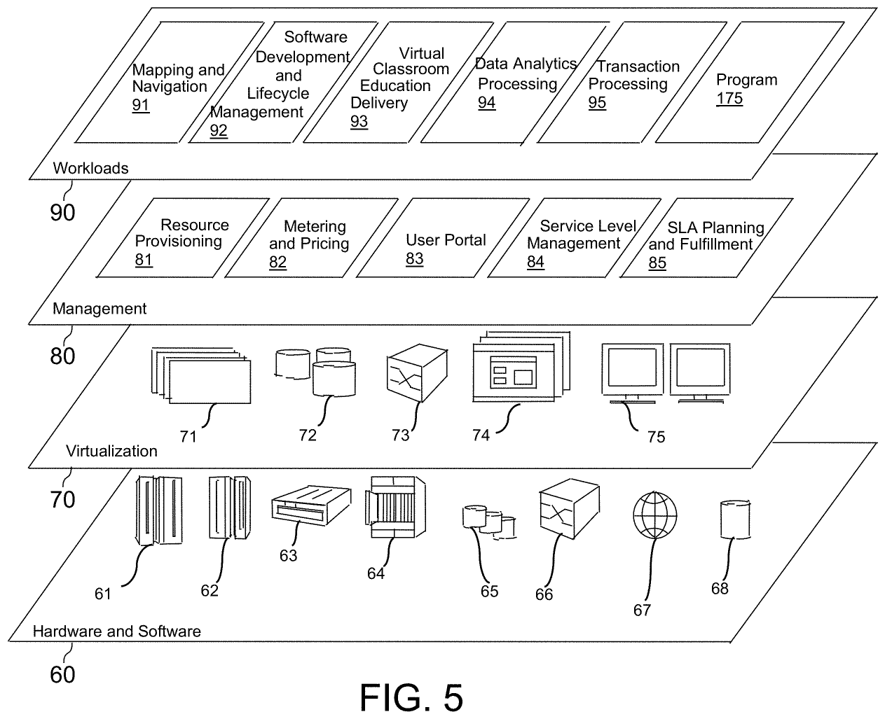

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and customer outcome prediction program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be collectively downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for predictive analysis of customer relationship management elements, the method comprising:
receiving service feature data associated with past services;
receiving customer feature data, including customer interaction outcome data, for a set of customers associated with the past services;
training a machine learning model according to the service feature data and the customer feature data; and
providing the machine learning model, the machine learning model configured for predicting a future customer interaction outcome probability according to service feature data associated with a current service, and customer feature data associated with customers of the current service.

2. The computer implemented method according to claim 1, wherein the customer interaction outcome data includes negative outcome data.

3. The computer implemented method according to claim 1, wherein the machine learning model comprises:
a classification model;
an anomaly detection model;
a learn-to-rank model; and
a time series model.

4. The computer implemented method according to claim 3, wherein the anomaly detection model comprises an autoencoder neural network model.

5. The computer implemented method according to claim 3, wherein training the learn-to-rank model comprises:
defining a service feature vector for each service;
defining a customer feature vector for each customer of the service;
concatenating the service feature vector and the customer feature vector; and
training the learn-to-rank model to rank customers using the concatenated service feature vector and the customer feature vector.

6. The computer implemented method according to claim 3, wherein training the time series model comprises:
converting binary data to continuous data; and
training a time series model using the continuous data.

7. The computer implemented method according to claim 1, wherein the future customer interaction outcome probability comprises a negative interaction outcome probability.

8. A computer program product for predictive analysis of customer relationship management elements, the computer program product comprising one or more computer readable storage devices and collectively stored program instructions on the one or more computer readable storage devices, the stored program instructions comprising:
program instructions to receive service feature data associated with past services;
program instructions to receive customer feature data, including customer interaction outcome data, for a set of customers associated with the past services;
program instructions to train a machine learning model according to the service feature data and the customer feature data; and
program instructions to provide the machine learning model, the machine learning model configured for predicting a future customer interaction outcome probability according to service feature data associated with a current service, and customer feature data associated with customers of the current service.

9. The computer program product according to claim 8, wherein the customer interaction outcome data includes negative outcome data.

10. The computer program product according to claim 8, wherein the machine learning model comprises:
a classification model;
an anomaly detection model;
a learn-to-rank model; and
a time series model.

11. The computer program product according to claim 10, wherein the anomaly detection model comprises an autoencoder neural network model.

12. The computer program product according to claim 10, wherein program instructions to train the learn-to-rank model comprise:
program instructions to define a service feature vector for each service;
program instructions to define a customer feature vector for each customer of the service;
program instructions to concatenate the service feature vector and the customer feature vectors; and
program instructions to train the learn-to-rank model to rank customers using concatenated service feature vector and the customer feature vectors.

13. The computer program product according to claim 10, wherein the program instructions to train the time series model comprise:
program instructions to convert binary data to continuous data; and
program instructions to train the time series model using the continuous data.

14. The computer program product according to claim 8, wherein the future customer interaction outcome probability comprises a negative interaction outcome probability.

15. A computer system for predictive analysis of customer relationship management elements, the computer system comprising:
one or more computer processors;
one or more computer readable storage devices; and
stored program instructions on the one or more computer readable storage devices for execution by the one or more computer processors, the stored program instructions comprising:
program instructions to receive service feature data associated with past services;
program instructions to receive customer feature data, including customer interaction outcome data, for a set of customers associated with the past services;
program instructions to train a machine learning model according to the service feature data and the customer feature data; and
program instructions to provide the machine learning model, the machine learning model configured for predicting a future customer interaction outcome probability according to service feature data associated with a current service, and customer feature data associated with customers of the current service.

16. The computer system according to claim 15, wherein the customer interaction outcome data includes negative outcome data.

17. The computer system according to claim 15, wherein the machine learning model comprises:
a classification model;
an anomaly detection model;
a learn-to-rank model; and
a time series model.

18. The computer system according to claim 17, wherein program instructions to train the learning-to-rank model comprise:
program instructions to define a service feature vector for each service;
program instructions to define a customer feature vector for each customer of the service;
program instructions to concatenate the service feature vector and the customer feature vectors; and
program instructions to train the learn-to-rank model to rank customers using concatenated service feature vector and customer feature vectors.

19. The computer system according to claim 17, wherein the program instructions to train the time series model comprise:
program instructions to convert binary data to continuous data; and
program instructions to train the time series model using the continuous data.

20. The computer system according to claim 15, wherein the future customer interaction outcome probability comprises a negative interaction outcome probability.
